(19) United States
(12) Patent Application Publication
(10) Pub. No.: US 2008/0260220 A1
(43) Pub. Date: Oct. 23, 2008

(54) REGISTRATION OF OPTICAL IMAGES OF SMALL ANIMALS

(75) Inventor: Salim Djeziri, Montreal (CA)

Correspondence Address: BERESKIN AND PARR, 40 KING STREET WEST, BOX 401, TORONTO, ON, M5H 3Y2, CA

(73) Assignee: ART ADVANCED RESEARCH TECHNOLOGIES INC., Ville-Saint-Laurent (CA)

(21) Appl. No.: 11/963,100

(22) Filed: Dec. 21, 2007

Related U.S. Application Data
(60) Provisional application No. 60/871,592, filed on Dec. 22, 2006.

(51) Int. Cl. G06K 9/00

(52) U.S. Cl. 382/128

(57) ABSTRACT

A method for registering a first imaging dataset of a small animal with a second imaging dataset of the animal includes defining a contour of the animal body and dividing it into subregions using skeleton lines. The subregions of the first dataset, once defined, are morphed individually into corresponding subregions of the second dataset. A set of lines may be found for defining each of the subregions, and an index determined which relates the lines of a subregion of the first dataset to those of a corresponding subregion of the second dataset. A pixel index may thereafter be determined for each of the lines, and used to map each pixel of a line to a corresponding list of pixels for the corresponding line of the other dataset.

### FIELD OF THE INVENTION

This application relates to optical imaging of turbid media such as small animals that is to be combined or used with other optical or non-optical imaging of the same media.

### BACKGROUND OF THE INVENTION

Optical imaging can provide valuable information about turbid media such as biological tissue. Recent developments in both hardware and software enable rapid acquisition and processing of optical data to generate optical images of tissues. The use of optical imaging of living tissue, such as breast, brain or whole body of small animals, is growing within the medical and pharmaceutical research communities. Its advantages over other imaging modalities, such as X-ray, ultrasound, PET or SPECT and MRI, is that it can provide rich optical spectrum analytical information about tissue composition and that the imaging is done using non-ionizing radiation (i.e., light) without any adverse effect on tissue. For example, chromophore information can help discern between oxygenated and deoxygenated blood, and is quite useful for understanding the function within the tissue. In some cases, an exogenous marker, whether fluorescent or a chromophore, may be injected into the tissue to aid in localizing or visualizing objects of interest. Markers can selectively attach to certain molecules within tissue and the concentration of a marker within tissue can reveal important information about the state of the tissue.

Because tissue is a turbid medium, namely it scatters light heavily, optical imaging is a challenge. Optical scatter in tissue largely results from changes in the index of refraction caused by cellular boundaries. Injected light thus becomes a diffuse glow when detected either at the other side of the tissue in transmission mode or at the same side of the tissue in reflection mode. In the imaging process, scattering of light within the tissue must be accounted for correctly if imaging with good spatial resolution is to be achieved. When light is injected into tissue, it is scattered and absorbed. The combination of the scattering and absorption of the light provides the overall attenuation of light between source and detector. In the case of a fluorophore, the absorbed light may be reemitted at a wavelength and time that varies as a function of the fluorophore properties.

Optical scatter, namely the density and level of contrast of index of refraction boundaries within tissue, is generally a source of structure-based biological or medical information, and not metabolism-based information. However, since the absorption and/or the fluorescent reemission is a rich source of the metabolism-based information of interest, and since the location within the tissue of this biological information is to be identified, optical scatter is determined within the imaging process to allow for proper spatial identification of concentration of fluorophore and/or chromophore concentrations. Generally, scatter information is obtained by acquiring time dependent optical information, namely through time domain or frequency domain optical data acquisition.

In some applications, it would be desirable to combine the benefit of the information provided by the optical imaging with the information obtained from a non-optical imaging technique of the same tissue at essentially the same time or from the same optical imaging modality of the same tissue at a different time. This comparison can however be difficult since the configuration of the data acquisition devices and the fundamental properties giving rise to contrast in the various imaging modalities are different.

### SUMMARY OF THE INVENTION

In accordance with the present invention, a method is provided for registering a first imaging dataset of a small animal, such as a mouse, with a second imaging dataset of the same small animal. The method involves first defining a contour of the small animal body for each of the first and second datasets. Using the contour, a set of skeleton lines is located, which effectively divides the body into a plurality of subregions. From the skeleton lines and the contour lines, the subregions are defined. This process may involve the extrapolation of the skeleton lines so as to extend them to a point of intersection with the contour. The subregions may thus be defined by closed loops formed by skeleton lines and contour lines. Registration parameter values are then generated for morphing each one of the subregions from the first dataset into a corresponding subregion in the second dataset.

The contour may be defined by a user via a user interface. In one embodiment, the contour may be defined using a separate camera image of the small animal as it is positioned for imaging, typically lying on its ventral or dorsal side. The imaging datasets may both be from the same imaging modality, such as optical imaging, or they may be derived from different modalities, such as one from optical imaging and one from X-ray imaging.

For defining a plurality of subregions, a set of lines parallel with a skeleton line may be found for each of the subregions. To find each set of lines, a skeleton line may be dilated to derive new lines. A line index may then be found that allows each of the lines for a given subregion of the first dataset to be related to a line of the corresponding subregion of the second dataset. Thereafter, pixels of the lines related by a line index may also be related to one another by determining a pixel index which maps each pixel of a given line to a corresponding list of pixels for the line to which the given line was related by the line index.

### BRIEF DESCRIPTION OF THE DRAWINGS

The invention will be better understood by way of the following detailed description with reference to the appended drawings in which:

FIG. 1 is an image of a mouse on an imaging support with the legs of the mouse secured with tape and the contour points and spline superimposed over the 2D image of the mouse;

FIG. 2 is a schematic view of a set of skeleton lines associated with the contour of the mouse;

FIG. 3 is a schematic view similar to that of FIG. 2 which indicates intersection points between the skeleton lines and the contour, and arrows indicative of a method of defining subregions by applying the “leftist” rule;

FIG. 4A is an image showing separated subregions of a mouse in a position A with the optical image of each subregions shown; and

FIG. 4B is an image showing separated subregions of a mouse in a position B with the optical image of each subregions shown.

### DETAILED DESCRIPTION

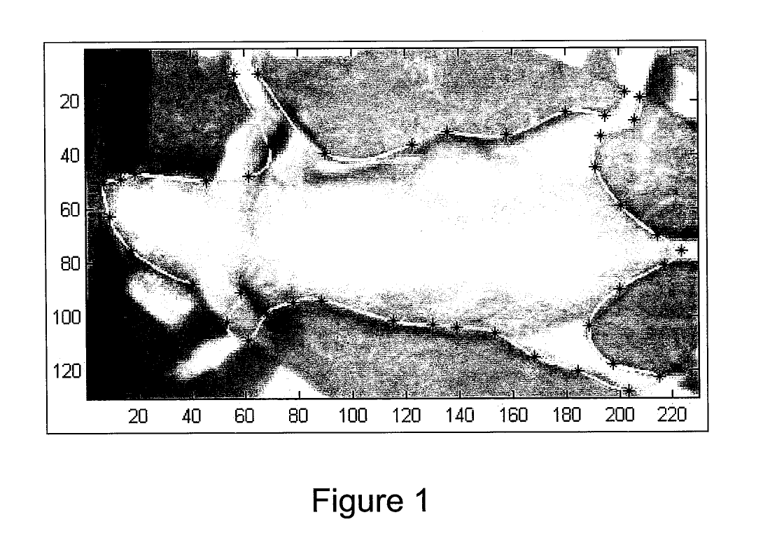

In small animal imaging, the tissue of the body of the animal is optically scanned, and may produce an image like that shown in FIG. 1, which is an optical image of a mouse. A typical optical imaging system may include a store of raw optical image data from a time dependent optical imaging system, such as a time domain or frequency domain system, that is processed to generate an image, either two-dimensional (2D) or three-dimensional (3D). An example of a commercially available time domain system able to produce such data from small animal imaging is EXPLORE OPTIX™, made by ART Advanced Research Technologies Inc., St-Laurent, QC, Canada.

The raw optical imaging data is typically processed to obtain a matrix of pixel or voxel data. In some cases, this data may be the optical scatter coefficient and optical absorption at each wavelength used for each pixel or voxel. Multi-wavelength absorption data can be converted into functional information for each pixel or voxel. When fluorescence is measured, the raw data may be analyzed to detect by lifetime and determine a fluorophore concentration associated with each pixel or voxel. The processing of the raw optical data into an image is integrated into the aforementioned scanning equipment.

A display in the optical scanning equipment may be used to show images of an animal, such as a mouse, taken either at different times or using different modalities, and allows the user to adjust the contour defining the shape of the animal. A first sketch of the contour is derived from images by applying standard contour detection algorithms. A user interface also allows a user to define landmark points. The shape contours of the two mouse images form two optical image datasets to be registered and are used by a module to generate registration parameter values, namely transform parameters to have the two image datasets be in registration when viewed.

The operation of the registration parameter generation module will now be described. This technique uses the shape contour of each mouse image. The shape contour can be obtained by a variety of techniques, and one simple embodiment is to use an overhead digital camera to acquire a 2D image, that is then processed automatically or using operator intervention to define the contour of the mouse.

In the present embodiment, a method for finding contours is applied to mice lying in a ventral or dorsal position. In this position, six distinct parts of the mouse body may be designated: head, four legs and the tail. The shape of the mouse is “splined”, by either computing the best cubic spline in the mean square error sense, that best approximates the previously extracted (shape) contour, or by allowing the user, via a graphical interface, to define control points over the perimeter of the mouse, and to thereafter generate the spline, which is representative of the mouse contour. These techniques may be done individually, or may both be used together in a sequential manner to produce a robust spline definition of the contour of the mouse. In this embodiment, it is important that the contour shape is well superimposed over the real boundary of the mouse. It is not necessary that it covers the full length of the legs or of the tail, or even of the head, but it has to cover a sufficient length of the mouse body, as shown in FIG. 1.

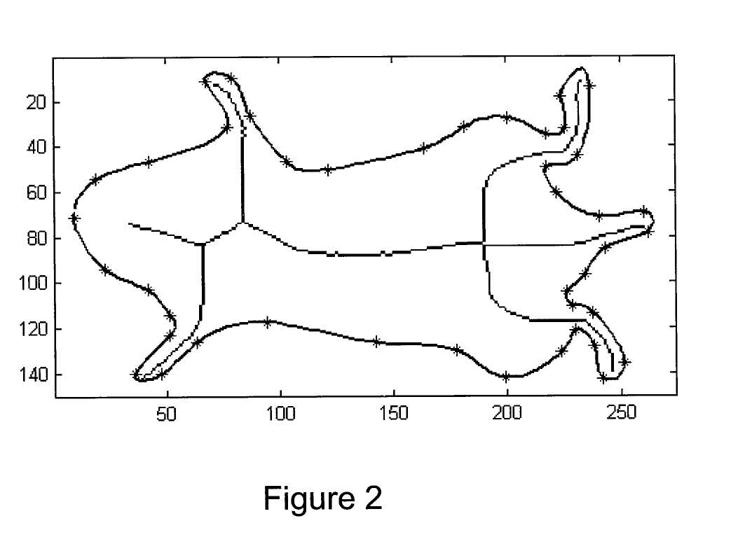

From a contour image such as that shown in FIG. 1, one may find a cubic spline that defines the body of the mouse. The internal region R of the mouse undergoes a skeletonization process, as shown in FIG. 2. The skeletonization process, or thinning process, is a morphological operation in image processing that reduces a binary object to minimally connected spokes. Conceptually, the skeleton is the medial axis of a binary object. The skeletonization process is a well-known operation in the field of image processing, and is described, for example, in “Haralick, Robert M., and Linda G. Shapiro, Computer and Robot Vision, Volume I, Addison-Wesley, 1992.”

The skeleton of the mouse, as shown in FIG. 2, is composed of at least six branches, each one following a protuberance of the contour shape. It is possible that the skeleton develops more than six branches, but the skeletonized image is cleaned of spurs and false branches by a process that eliminates branches below a threshold length. Once the six branches are determined, the internal region of the mouse is systematically divided in six parts as follows.

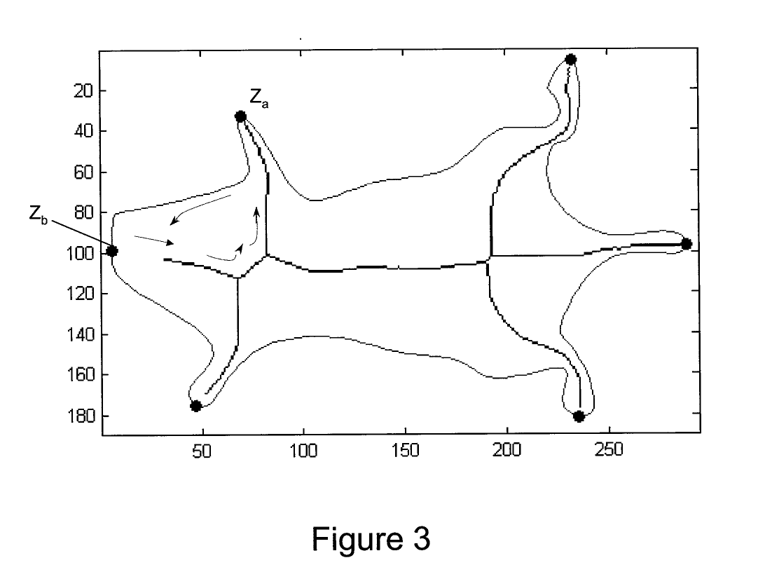

To split the body in six parts the following tracking process is used. Each extremity E_{i=1, . . . 6} of the skeleton is extrapolated to extend it to a point Z_{i=1, . . . 6} at which it intersects the spline contour. These intersection points are shown together with the spline contour in FIG. 3. Beginning from one of the extended points, for example point Zₐ shown in the figure, the sequence of contour points of the spline is followed until reaching another extended extremity, such as point Z_{b}. From this point, the sequence of pixels of the skeleton is followed. When reaching a fork in the path of the skeleton pixels, i.e., a pixel for which there are multiple adjacent pixels connecting to branches in different directions, the “leftist” rule is applied. The leftist rule involves selecting the branch that is at a left most angle relative to the direction being followed along the skeleton. Notably, this rule applies to a spline turning counter clockwise and, for a spline that turns clockwise, it is the “rightest” rule that would be applied.

This tracking process is repeated for each of the regions of the mouse image, and provides six closed curves each delimiting a different part of the body of the mouse. The same is done with the second mouse image, such that six different regions in each the two mouse images A and B are determined.

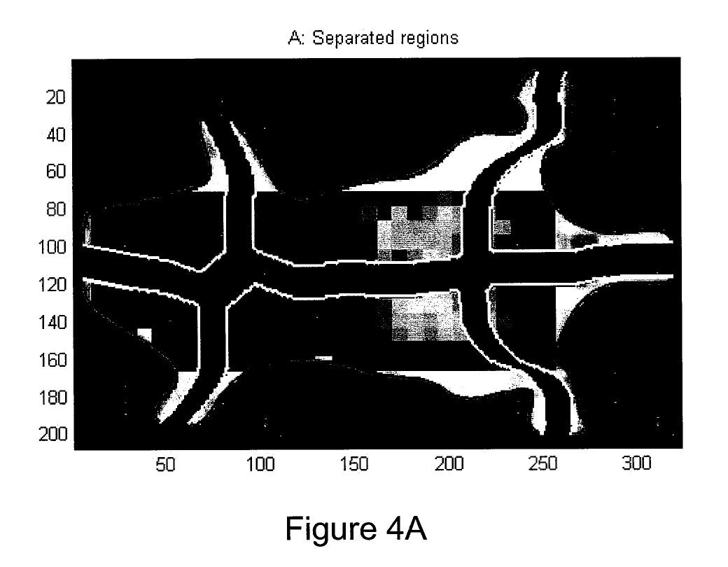

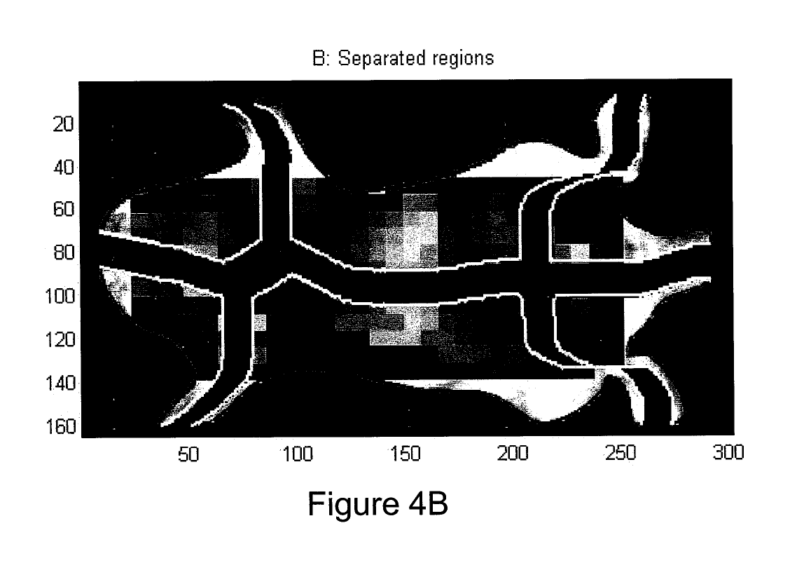

To co-registered and compare the two mouse images, corresponding branches from the same region of each mouse image are examined. For two corresponding branches, the lengths are compared and the longer of the two is truncated to the length of the shorter one. That is, the length of a given branch in image A is compared to the length of the corresponding branch in image B, and the longer of the two compared branches is truncated to match the length of the shorter one. This process is repeated for each of the six branches. The different regions in each of the images are then split apart from one another, as shown in FIGS. 4A and 4B (FIG. 4A showing the separated portions of mouse image A and FIG. 4B showing the separated portions of mouse image B). This ensures that parts of the body put in correspondence are approximately of the same size. If the images of the two mice are not produced with the same modality, or do not have the same resolution, a scale factor is taken into account in computing the minimum length of S_{A} or S_{B} and when truncating the longest branch. Moreover, the truncation of the skeleton may induce a rearrangement of control points of the spline such that it comes close to the extremity of the truncated branch.

The co-registration is achieved by warping each part of the body of the mouse in image A, to its corresponding part of the body of the mouse in image B. First, each of the separated parts of the mouse body image is described by a set of lines G (i.e., contiguous pixels) that are parallel to the line of the skeleton. This is done using the following steps:
1) For each skeleton line, the line is put in the set G and treated as a region R.
2) A dilation operation is applied to the pixels of region R (using a 3×3 mask) such that a new line corresponding to the dilated position of R is derived. This new line is then associated with the region of interest, being included in a set of parallel scan lines G that will define the region. Notably, only the part of dilated R that is inside the part of the body is considered, although this may cause some pixels of the contour boundary of the body to be considered multiple times.
3) Step 2 is repeated for the region R until the newly added line is exactly the boundary of the part of the body being examined.

The warping process comprises relating values of pixels of lines from set G_{A} to pixels of lines from set G_{B} and vice versa. It will be recognized that G_{A} and G_{B} may have not exactly the same number of lines. The terms N_{A} and N_{B} are used to represent the number of lines in the sets G_{A} and G_{B}, respectively. For each of the N_{A} lines of G_{A}, the steps are as follows:
Extract line number k (labeled “Lₖ”) from G_{A} (where k=1, . . . , N_{A})
Compute the index: p=k*N_{B}/N_{A} to determine the line (Lₚ) of set G_{B} which corresponds to the line Lₖ
Extract line Lₚ from G_{B}
Using the terms nₐ and n_{b} to represent the number of pixels of lines Lₖ and Lₚ, respectively, for each of the nₐ pixels of line Lₖ, perform the following steps:
   for each index a, compute index b=a*n_{b}/nₐ
   Add the pixel at index a of line Lₖ to the list of pixels associated with the pixel of index b of line Lₚ.

When all of the iterations are finished, reduce each associated list of pixels to its average. From this a lookup table is produced that goes from A to B.

Those skilled in the art will recognize that one may apply the same steps for making a lookup table that goes from A to B, and that lookup tables will typically be made for each of the six parts of the body for each image. Each of the six lookup tables are gathered into one to create two main lookup tables, one for going from mouse A to B, and the other for going for mouse B to A.

This co-registration technique ensures the following. Points of the skeleton (medial axis) of one mouse are in correspondence with points of skeleton of mouse B. Points on the contour of one mouse are in correspondence with points on the contour of the other mouse. Points in the body of one mouse are in correspondence with points in the body of the other mouse, by taking into account the distance of that point to the skeleton and/or the contour of the mouse. This is done with a technique described above, that considers lines of scan that are parallel to the skeleton through G_{A} and G_{B} and deriving the look-up table using the technique of warping described above. This technique does not use any physical fiducial markers. It will be appreciated that the additional use of fiducial markers is possible.

While the invention has been described in connection with specific embodiments thereof, it will be understood that it is capable of further modifications and this application is intended to cover any variations, uses, or adaptations of the invention following, in general, the principles of the invention and including such departures from the present disclosures as come within known or customary practice within the art to which the invention pertains and as may be applied to the essential features herein before set forth, and as follows in the scope of the appended claims.

1. A method for registering a first imaging dataset of a small animal with a second imaging dataset of the same small animal, the method comprising:
defining a contour of the small animal body for said first and said second imaging datasets;
locating a set of skeleton lines from the contour;
defining a plurality of subregions bounded by said contour and skeleton lines of said contour; and
generating registration parameter values for morphing each one of said subregions from said first dataset into corresponding subregions in said second dataset.

2. A method according to claim 1, wherein said first and said second imaging datasets are both optical image datasets, and wherein said contour is defined by a separate camera image of the small animal as positioned during said imaging.

3. A method according to claim 2, wherein the small animal is a mouse lying in ventral or dorsal side.

4. A method according to claim 1, wherein said first dataset is produced by optical imaging and said second dataset is produced by X-ray imaging.

5. A method according to claim 1 wherein defining a plurality of subregions comprises extrapolating the skeleton lines to points at which they intersect the contour, and defining the subregions by closed loops formed by the skeleton lines and the contour.

6. A method according to claim 5 wherein defining a plurality of subregions further comprises finding a set of lines for each subregion that are parallel with a skeleton line.

7. A method according to claim 6 wherein finding a set of lines for each subregion comprises, for each subregion, dilating a skeleton line to derive new lines.

8. A method according to claim 5 wherein generating registration parameter values further comprises determining a line index for relating each line of a subregion of the first dataset to a line of a corresponding subregion of the second dataset.

9. A method according to claim 8 wherein generating registration parameter values further comprises, for a first line of a subregion of a first dataset, determining an index for relating each pixel of first line to a corresponding list of pixels for a line to which the first line was related by said line index.
